(19) United States
(12) Patent Application Publication
(10) Pub. No.: US 2026/0269472 A1
(43) Pub. Date: Sep. 10, 2026

(54) FRONT-END SYSTEMS FOR IMPROVED RF COMMUNICATION

(71) Applicant: SKYWORKS SOLUTIONS, INC., Irvine, CA (US)

(72) Inventor: David Richard Pehlke, Westlake Village, CA (US)

(21) Appl. No.: 19/557,272

(22) Filed: Mar. 5, 2026

Related U.S. Application Data
(60) Provisional application No. 63/767,033, filed on Mar. 5, 2025.

(51) Int. Cl. H01Q 5/307; H04B 1/00; H04B 1/40; H04B 7/06

(52) U.S. Cl. CPC H01Q 5/307; H04B 1/006; H04B 1/40; H04B 7/0602

(57) ABSTRACT

A radio frequency circuit assembly is disclosed. An example radio frequency circuit assembly comprises a plurality of antenna switch modules, where each antenna switch module is coupled to a transmit signal contact via a transmit band filter, a plurality of receive signal contacts via a respective plurality of receive band filters, and a plurality of antenna contacts. The antenna switch modules are configured such that each of the plurality of antenna contacts are selectively coupled to the transmit signal contact.

### CROSS-REFERENCE TO RELATED APPLICATIONS

This application claims priority under 35 U.S.C. § 119(e) to U.S. Provisional Application 63/767,033, titled FRONT-END SYSTEMS FOR IMPROVED RF COMMUNICATION, filed on Mar. 5, 2025, which is hereby incorporated by reference in its entirety for all purposes.

### BACKGROUND

### Field

Embodiments of this disclosure relate to electronic systems, and in particular to radio frequency electronics such as radio frequency front-end modules.

### Description of the Related Technology

Radio frequency (RF) communication systems can be used for transmitting and/or receiving signals of a wide range of frequencies. For example, an RF communication system can be used to wirelessly communicate RF signals in a frequency range of about 30 kHz to 350 GHz, such as in the range of about 400 MHz to about 7.125 GHz for Frequency Range 1 (FR1) of the Fifth Generation (5G) communication standard, in the range of about 24.250 GHz to about 71.000 GHz for Frequency Range 2 (FR2) of the 5G communication standard, or in the range of about 7.125 GHz to about 24.250 GHz for Frequency Range 3 (FR3) that may form part of next generation 5G communication standards or future 6G communication standards.

Examples of RF communication systems include, but are not limited to, mobile phones, tablets, base stations, network access points, customer-premises equipment (CPE), laptops, and wearable electronics. CPE may include routers, network switches, residential gateways, set-top boxes, fixed mobile convergence products, home networking adapters and Internet access gateways.

### SUMMARY

According to one aspect of the present invention there is provided, a radio frequency circuit assembly, comprising a first transmit signal contact and a second transmit signal contact, each transmit signal contact being configured to receive a respective amplified radio frequency transmit signal; a first plurality of receive signal contacts and a second plurality of receive signal contacts, each receive signal contact being couplable to a respective low noise amplifier; and a first plurality of antenna contacts and a second plurality of antenna contacts, each antenna contact being couplable to a respective antenna. The radio frequency circuit assembly further comprises a first antenna switching module that is coupled to the first transmit signal contact via a first transmit band filter, the first antenna switching module being coupled to the first plurality of receive signal contacts via a respective first plurality of receive band filters, and the first antenna switching module being coupled to the first plurality of antenna contacts such that each of the first plurality of antenna contacts are selectively coupled to the first transmit signal contact. The radio frequency circuit assembly further comprises a second antenna switching module that is coupled to the second transmit signal contact via a second transmit band filter, the second antenna switching module being coupled to the second plurality of receive signal contacts via a respective second plurality of receive band filters, and the second antenna switching module being coupled to the second plurality of antenna contacts such that each of the second plurality of antenna contacts are selectively coupled to the second transmit signal contact.

In one example, the first antenna switching module is coupled to the second antenna switching module by a trace such that each of the second plurality of antenna contacts are selectively coupled to the first transmit signal contact.

In one example, the radio frequency circuit assembly further comprises a third antenna switching module that is coupled to a third transmit signal contact via a third transmit band filter, the third antenna switching module being coupled to a third plurality of receive signal contacts via a respective third plurality of receive band filters, and the third antenna switching module being coupled to a third plurality of antenna contacts such that each of the third plurality of antenna contacts are selectively coupled to the third transmit signal contact.

In one example, the first transmit band filter and the second transmit band filter are low pass filters, and the first plurality of receive band filters and the second plurality of receive band filters are band pass filters.

In one example, the respective radio frequency transmit signals have a frequency in a range of 7 gigahertz to 24 gigahertz.

In one example, the radio frequency circuit assembly is configured to provide sounding reference signaling by transmitting the radio frequency transmit signal using the plurality of antennas.

In one example, the first plurality of receive signal contacts are respectively selectively coupled to the first plurality of antenna contacts, and the second plurality of receive signal contacts are respectively selectively coupled to the second plurality of antenna contacts.

According to another embodiment, there is provided a front-end module comprising a first power amplifier and a second power amplifier, each power amplifier being configured to receive a respective radio frequency transmit signal for amplification; a first plurality of low noise amplifiers and a second plurality of low noise amplifiers; a first plurality of antenna contacts and a second plurality of antenna contacts, each antenna contact being couplable to a respective antenna; a first antenna switching module and a second antenna switching module. The first antenna switching module is coupled to the first power amplifier via a first transmit band filter, the first antenna switching module is coupled to the first plurality of low noise amplifiers via a respective first plurality of receive band filters, and the first antenna switching module is coupled to the first plurality of antenna contacts such that each of the first plurality of antenna contacts are selectively coupled to the first power amplifier. The second antenna switching module is coupled to the second power amplifier via a second transmit band filter, the second antenna switching module is coupled to the second plurality of low noise amplifiers via a respective second plurality of receive band filters, and the second antenna switching module is coupled to the second plurality of antenna contacts such that each of the second plurality of antenna contacts are selectively coupled to the second power amplifier.

In one example, the first antenna switching module is coupled to the second antenna switching module by a trace such that each of the second plurality of antenna contacts are selectively coupled to the first power amplifier.

In one example, the front-end module further comprises a third antenna switching module that is coupled to a third power amplifier via a third transmit band filter, the third antenna switching module being coupled to a third plurality of low noise amplifiers via a respective third plurality of receive band filters, and the third antenna switching module being coupled to a third plurality of antenna contacts such that each of the third plurality of antenna contacts are selectively coupled to the third power amplifier.

In one example, the first transmit band filter and the second transmit band filter are low pass filters, and the first plurality of receive band filters and the second plurality of receive band filters are band pass filters.

In one example, the first power amplifier and the second power amplifier are configured for concurrent transmission of amplified radio frequency transmit signals.

In one example, the respective radio frequency transmit signals have a frequency in a range of 7 gigahertz to 24 gigahertz.

In one example, the radio frequency circuit assembly is configured to provide sounding reference signaling by transmitting the radio frequency transmit signal using the plurality of antennas.

In one example, the first plurality of low noise amplifiers are respectively selectively coupled to the first plurality of antenna contacts, and the second plurality of low noise amplifiers are respectively selectively coupled to the second plurality of antenna contacts.

According to another embodiment, there is provided a wireless communication device comprising a first power amplifier and a second power amplifier, each power amplifier being configured to receive a respective radio frequency transmit signal for amplification; a first plurality of low noise amplifiers and a second plurality of low noise amplifiers; a first plurality of antennas and a second plurality of antennas, each of the antennas being configured to receive and transmit radio frequency signals; and first and second antenna switching modules. The first antenna switching module is coupled to the first power amplifier via a first transmit band filter, the first antenna switching module being coupled to the first plurality of low noise amplifiers via a respective first plurality of receive band filters, and the first antenna switching module being coupled to the first plurality of antennas such that each of the first plurality of antennas are selectively coupled to the first power amplifier. The second antenna switching module is coupled to the second power amplifier via a second transmit band filter, the second antenna switching module being coupled to the second plurality of low noise amplifiers via a respective second plurality of receive band filters, and the second antenna switching module being coupled to the second plurality of antennas such that each of the second plurality of antennas are selectively coupled to the second power amplifier.

In one example, the wireless communication device further comprises a transceiver configured to generate the respective radio frequency transmit signals.

In one example, the wireless communication device is one of a mobile device, an automotive electronics device, a base station, a network access points, or other customer-premises equipment.

According to another embodiment, there is provided a radio frequency circuit assembly, comprising: a first transmit signal contact and a second transmit signal contact, each transmit signal contact being configured to receive a respective amplified radio frequency transmit signal; a plurality of receive signal contacts, each receive signal contact being couplable to a respective low noise amplifier; a first antenna contact and a plurality of second antenna contacts, each antenna contact being couplable to a respective antenna; a first transmit band filter connected to the first transmit signal contact and the first antenna contact; and an antenna switching module that is coupled to the second transmit signal contact via a second transmit band filter, the antenna switching module being coupled to the plurality of receive signal contacts via a respective plurality of receive band filters, and the antenna switching module being coupled to the plurality of second antenna contacts such that each of the plurality of second antenna contacts are selectively coupled to the second transmit signal contact.

In one example, the first antenna contact is only connected to the transmit path from the first transmit signal contact and the first transmit band filter.

In one example, the first antenna contact is not connected to a switch.

In one example, the plurality of receive signal contacts are respectively selectively coupled to the plurality of second antenna contacts.

In one example, the radio frequency circuit assembly further comprises a second antenna switching module that is coupled to a second plurality of receive signal contacts via a respective second plurality of receive band filters, the second antenna switching module being coupled to a plurality of third antenna contacts such that each of the plurality of third antenna contacts are respectively selectively coupled to the second plurality of receive signal contacts.

In one example, the antenna switching module is coupled to the second antenna switching module by a trace such that each of the plurality of third antenna contacts are selectively coupled to the second transmit signal contact.

In one example, the radio frequency circuit assembly further comprises a third transmit signal contact, the second antenna switching module being coupled to the third transmit signal contact via a third transmit band filter, and each of the plurality of third antenna contacts being selectively coupled to the third transmit signal contact.

In one example, the first transmit band filter and the second transmit band filter are low pass filters, and the plurality of receive band filters are band pass filters.

In one example, the respective radio frequency transmit signals have a frequency in a range of 7 gigahertz to 24 gigahertz.

In one example, the radio frequency circuit assembly is configured to provide sounding reference signaling by transmitting the radio frequency transmit signal using the plurality of antennas.

According to another embodiment, there is provided a front-end module comprising a first power amplifier and a second power amplifier, each power amplifier being configured to receive a respective radio frequency transmit signal for amplification; a plurality of low noise amplifiers; a first antenna contact and a plurality of second antenna contacts, each antenna contact being couplable to a respective antenna; a first transmit band filter connected to the first power amplifier and the first antenna contact; and an antenna switching module. The antenna switching module is coupled to the second power amplifier via a second transmit band filter, the antenna switching module being coupled to the plurality of low noise amplifiers via a respective plurality of receive band filters, and the antenna switching module being coupled to the plurality of second antenna contacts such that each of the plurality of second antenna contacts are selectively coupled to the second power amplifier.

In one example, the first antenna contact is only connected to the transmit path from the first power amplifier and the first transmit band filter.

In one example, the first antenna contact is not connected to a switch.

In one example, the plurality of low noise amplifiers are respectively selectively coupled to the plurality of second antenna contacts.

In one example, the front-end module further comprises a second antenna switching module that is coupled to a second plurality of low noise amplifiers via a respective second plurality of receive band filters, the second antenna switching module being coupled to a plurality of third antenna contacts such that each of the plurality of third antenna contacts are respectively selectively coupled to the second plurality of low noise amplifiers.

In one example, the antenna switching module is coupled to the second antenna switching module by a trace such that each of the plurality of third antenna contacts are selectively coupled to the second power amplifier.

In one example, the front-end module further comprises a third power amplifier, the second antenna switching module being coupled to the third power amplifier via a third transmit band filter, and each of the plurality of third antenna contacts being selectively coupled to the third power amplifier.

In one example, the first transmit band filter and the second transmit band filter are low pass filters, and the plurality of receive band filters are band pass filters.

In one example, the first power amplifier and the second power amplifier are configured for concurrent transmission of amplified radio frequency transmit signals.

In one example, wherein the first power amplifier has a higher power rating than the second power amplifier.

In one example, the respective radio frequency transmit signals have a frequency in a range of 7 gigahertz to 24 gigahertz.

In one example, the radio frequency circuit assembly is configured to provide sounding reference signaling by transmitting the radio frequency transmit signal using the plurality of antennas.

According to another embodiment, there is provided a wireless communication device comprising a first power amplifier and a second power amplifier, each power amplifier being configured to receive a respective radio frequency transmit signal for amplification; a plurality of low noise amplifiers; a first antenna and a plurality of second antennas, each of the antennas being configured to receive and transmit radio frequency signals; a first transmit band filter connected to the first power amplifier and the first antenna; and an antenna switching module. The antenna switching module that is coupled to the second power amplifier via a second transmit band filter, the antenna switching module being coupled to the plurality of low noise amplifiers via a respective plurality of receive band filters, and the antenna switching module being coupled to the plurality of second antennas such that each of the plurality of second antennas are selectively coupled to the second power amplifier.

In one example, the wireless communication device further comprises a transceiver configured to generate the respective radio frequency transmit signals.

In one example, the wireless communication device is one of a mobile device, an automotive electronics device, a base station, a network access points, or other customer-premises equipment.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a schematic diagram of one example of a communication network;

FIG. 2A is a schematic diagram of one example of a communication link using carrier aggregation;

FIG. 2B illustrates various examples of uplink carrier aggregation for the communication link of FIG. 2A;

FIG. 2C illustrates various examples of downlink carrier aggregation for the communication link of FIG. 2A;

FIG. 3A is a schematic diagram of one example of a downlink channel using multi-input and multi-output (MIMO) communications;

FIG. 3B is schematic diagram of one example of an uplink channel using MIMO communications;

FIG. 3C is schematic diagram of another example of an uplink channel using MIMO communications;

FIG. 4 is a schematic diagram of an example dual connectivity network topology;

FIG. 5A is a schematic diagram of one example of a communication system that operates with beamforming;

FIG. 5B is a schematic diagram of one example of beamforming to provide a transmit beam;

FIG. 5C is a schematic diagram of one example of beamforming to provide a receive beam;

FIG. 6 is an example block diagram of a front-end system for a radio frequency communications device;

FIG. 7 is an example front-end system for a radio frequency communications device according to a first embodiment of the present disclosure;

FIG. 8 is an example of a front-end system for a radio frequency communications device according to a second embodiment of the present disclosure;

FIG. 9A is an example of a front-end system for a radio frequency communications device according to a third embodiment of the present disclosure;

FIG. 9B is an example of an internal circuit for the antenna switch module of FIG. 9A; and

FIG. 10 is a schematic block diagram of one embodiment of a wireless communication device that may include a radio frequency circuit assembly according to aspects of the present disclosure.

### DETAILED DESCRIPTION

The following detailed description of certain embodiments presents various descriptions of specific embodiments. However, the innovations described herein can be embodied in a multitude of different ways, for example, as defined and covered by the claims.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE). 5G technology is also referred to herein as 5G New Radio (NR). 5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

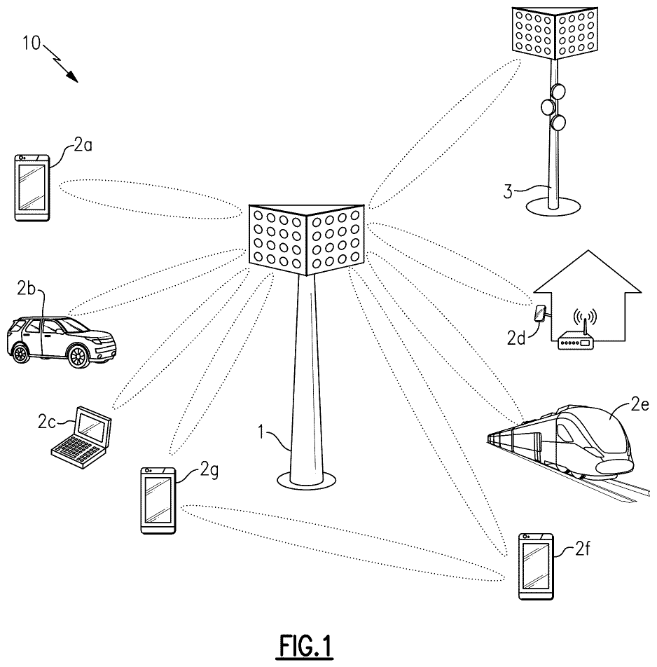

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

The communication links can operate over a wide variety of frequencies. In certain implementations, communications are supported using 5G NR technology over one or more frequency bands that are less than 7 Gigahertz (GHz) and/or over one or more frequency bands that are greater than 7 GHz. For example, the communication links can serve Frequency Range 1 (FR1), Frequency Range 2 (FR2), Frequency Range 3 (FR3), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz. Cellular user equipment can communicate using beamforming and/or other techniques over a wide range of frequencies, including, for example, FR3 (7 GHz to 24 GHz), FR2-1 (24 GHz to 52 GHz), FR2-2 (52 GHz to 71 GHz), and/or FR 1 (400 MHz to 7125 MHz).

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

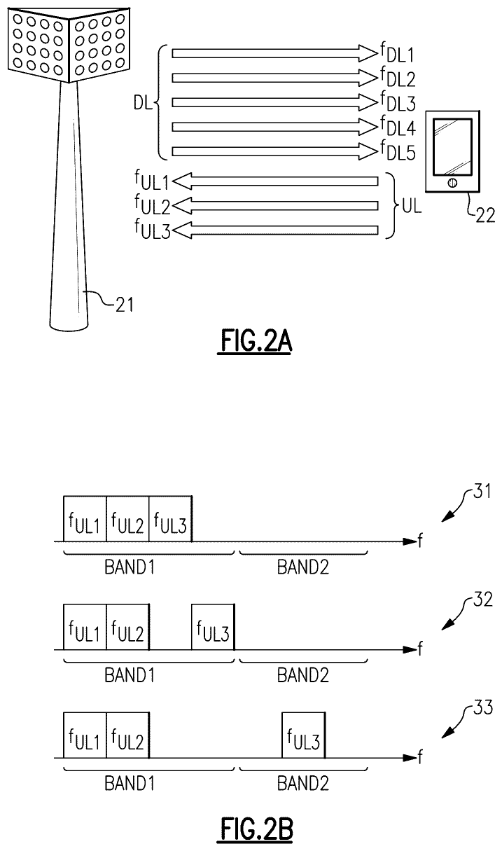

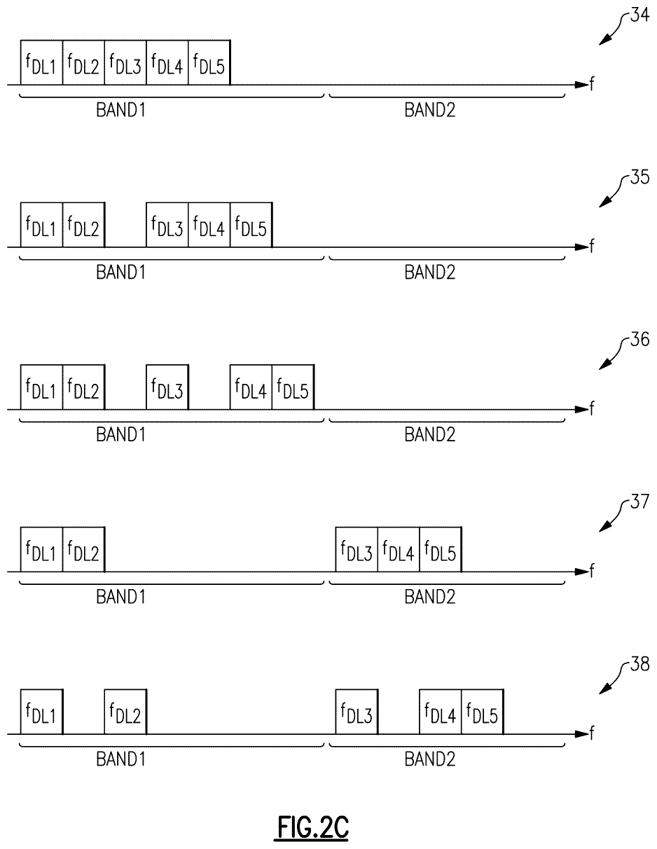

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21. Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31 to 33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more component carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1}, and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34 to 38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A to 2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using an SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink. Furthermore, NR-U can operate on top of LAA/eLAA over a 5 GHz band (5150 to 5925 MHz) and/or a 6 GHz band (5925 MHz to 7125 MHz).

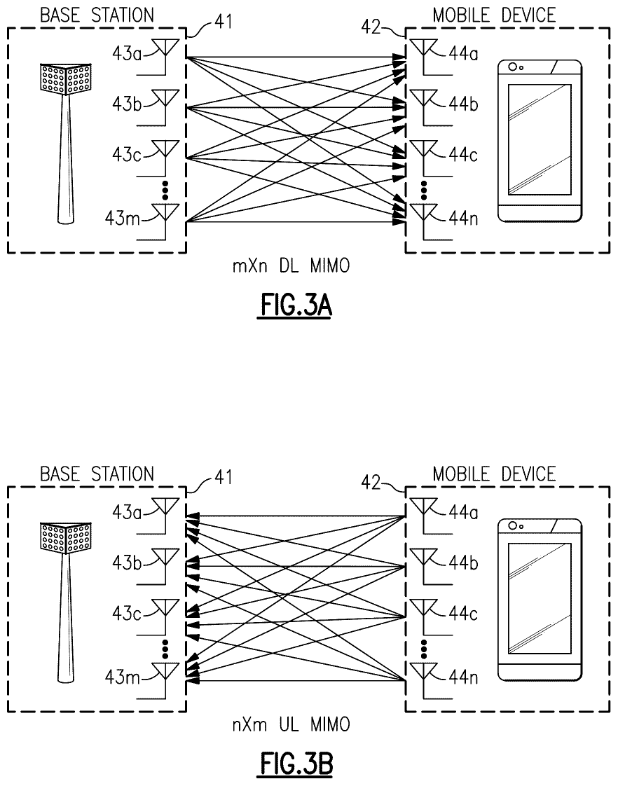

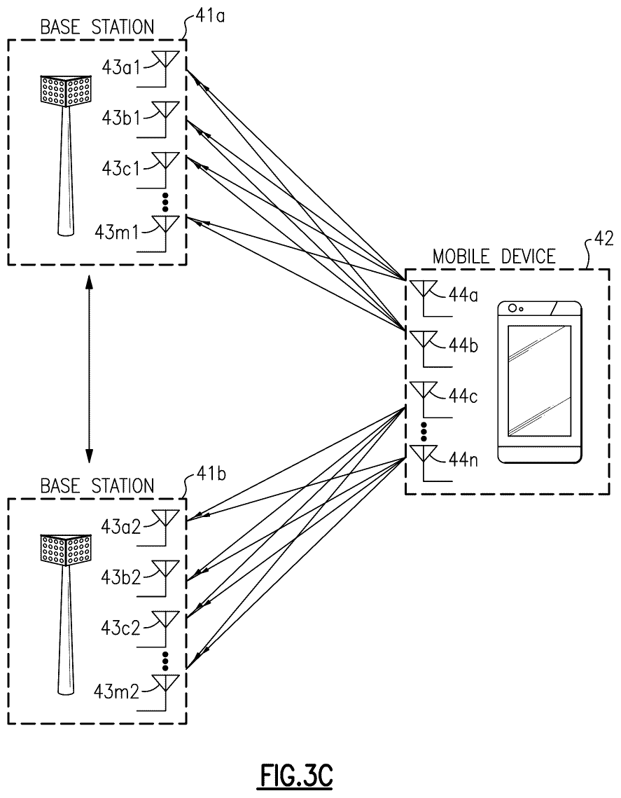

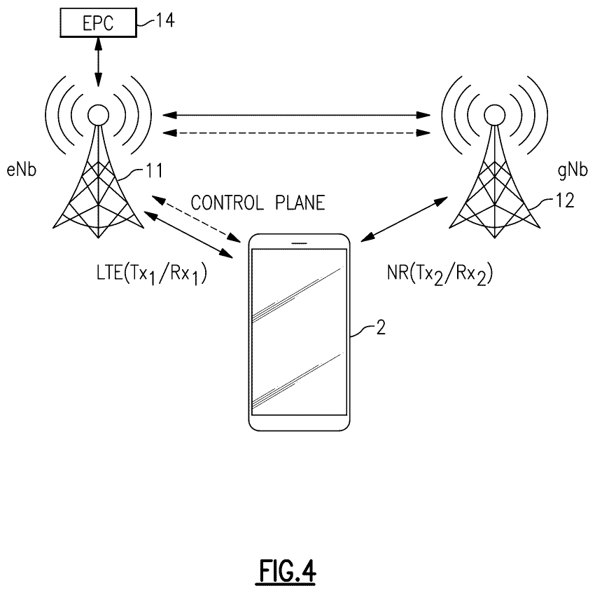

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . , 43m of the base station 41 and receiving using N antennas 44a, 44b, 44c, . . . , 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4 ×4 UL MIMO refers to MIMO uplink communications using four UE antennas and four base station antennas.

In the example shown in FIG. 3B, uplink MIMO communications are provided by transmitting using N antennas 44a, 44b, 44c, . . . , 44n of the mobile device 42 and receiving using M antennas 43a, 43b, 43c, . . . , 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is a schematic diagram of another example of an uplink channel using MIMO communications. In the example shown in FIG. 3C, uplink MIMO communications are provided by transmitting using N antennas 44a, 44b, 44c, . . . , 44n of the mobile device 42. Additionally a first portion of the uplink transmissions are received using M antennas 43a1, 43b1, 43c1, . . . , 43m1 of a first base station 41a, while a second portion of the uplink transmissions are received using M antennas 43a2, 43b2, 43c2, . . . , 43m2 of a second base station 41b. Additionally, the first base station 41a and the second base station 41b may communicate with one another over wired, optical, and/or wireless links.

The MIMO scenario of FIG. 3C illustrates an example in which multiple base stations cooperate to facilitate MIMO communications.

FIG. 4 is a schematic diagram of an example dual connectivity network topology. This architecture can leverage LTE legacy coverage to ensure continuity of service delivery and the progressive rollout of 5G cells. A UE 2 can simultaneously transmit dual uplink LTE and NR carrier. The UE 2 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 4. The eNB 11 can provide a connection with a core network, such as an Evolved Packet Core (EPC) 14. The gNB 12 can communicate with the core network via the eNB 11. Control plane data can be wirelessly communicated between the UE 2 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 2. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G and 5G carriers being simultaneously transmitted from a UE. Transmitting both 4G and 5G carriers in a UE, such as a phone, typically involves two power amplifiers (PAs) being active at the same time. Traditionally, having two power amplifiers active simultaneously would involve the placement of one or more additional power amplifiers specifically suited for EN-DC operation. Additional board space and expense is incurred when designing to support such EN-DC/NSA operation.

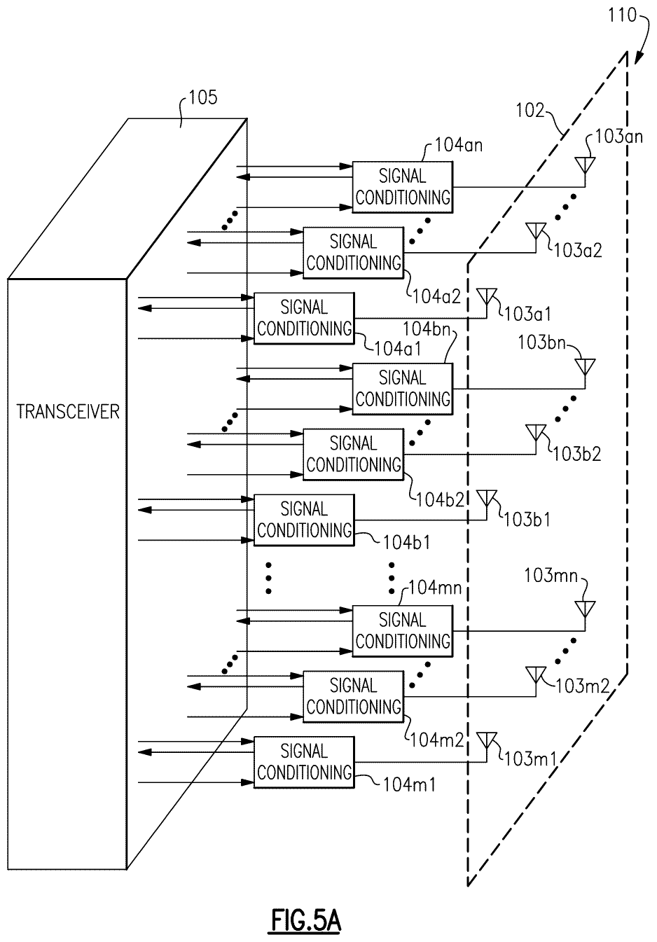

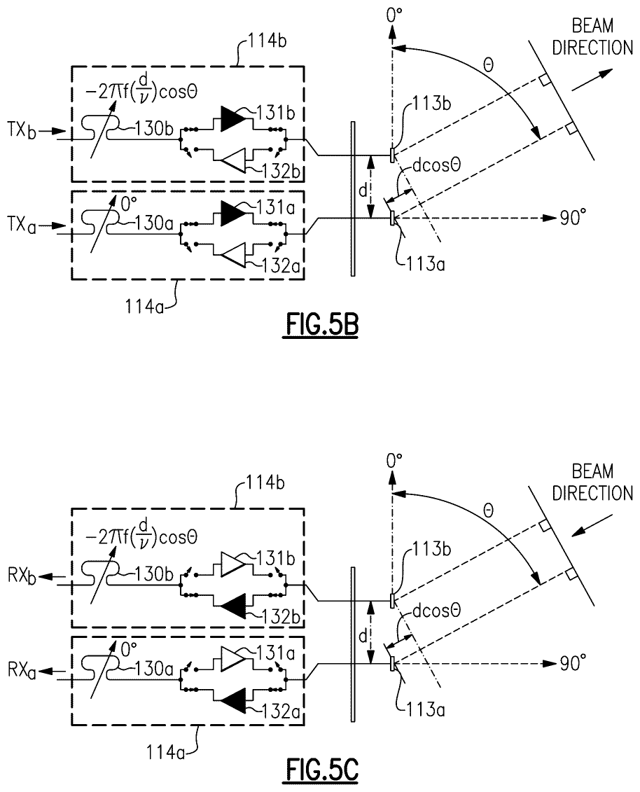

FIG. 5A is a schematic diagram of one example of a communication system 110 that operates with beamforming. The communication system 110 includes a transceiver 105, signal conditioning circuits 104a1, 104a2, . . . , 104an, 104b1, 104b2, . . . , 104bn, 104m1, 104m2, . . . , 104mn, and an antenna array 102 that includes antenna elements 103a1, 103a2, . . . , 103an, 103b1, 103b2, . . . , 103bn, 103m1, 103m2, . . . , 103mn.

Communications systems that communicate using millimeter wave carriers (for instance, 30 GHz to 350 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal propagates for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as including two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle θ can be achieved. For example, when the first phase shifter 130a has a reference value of 0°, the second phase shifter 130b can be controlled to provide a phase shift of about −2πf (d/v) cos(θ) radians, where f is the fundamental frequency of the transmit signal, d is the distance between the antenna elements, v is the velocity of the radiated wave, and π is the mathematic constant pi.

In certain implementations, the distance d is implemented to be about ½λ, where λ, is the wavelength of the fundamental component of the transmit signal. In such implementations, the second phase shifter 130b can be controlled to provide a phase shift of about −π cos(θ) radians to achieve a transmit beam angle θ.

Accordingly, the relative phase of the phase shifters 130a and 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal to −2πf(d/v) cos(θ) radians to achieve a desired receive beam angle θ. In implementations in which the distance d corresponds to about ½λ, the phase difference can be selected to about equal to −π cos(θ) radians to achieve a receive beam angle θ.

Although various equations for phase values to provide beamforming have been provided, other phase selection values are possible, such as phase values selected based on implementation of an antenna array, implementation of signal conditioning circuits, and/or a radio environment.

In cellular networks, such as 5G networks, Sounding Reference Signal (SRS) features can be enabled to determine channel qualities of a communication link between user equipment (UE) (for example, a wireless device such as a mobile phone) and a base station. SRS symbols are transmitted on uplink and processed by the network to estimate the quality of the wireless channel at different frequencies. For instance, the SRS symbols transmitted by the UE can be used by the base station to estimate the quality of the uplink channel for large bandwidths outside the assigned frequency span to the UE.

For the case of 4×4 MIMO, SRS relies on the transmission in uplink (UL) of known symbols to each of four receive antennas using Sounding Reference Signal Antenna Port Switching (SRS-AS). By receiving each of these known transmissions from each antenna, the gNodeB base station can develop an accurate channel model for the RF path from each of the antennas back to the gNodeB. Additionally, with respect to downlink (DL), the reciprocal nature of the UL and DL in TDD enables a much better transfer function for each of the antenna RF channel models, and the SNR can be significantly improved for both higher order MIMO as well as higher order receive (Rx) diversity.

Front-end systems can be used to process signals of a wide range of frequencies. For example, certain front-end systems can operate using one or more low bands (for example, RF signal bands having a frequency content of 1 GHz or less, also referred to herein as LB), one or more mid bands (for example, RF signal bands having a frequency content between 1 GHz and 2.3 GHz, also referred to herein as MB), one or more high bands (for example, RF signal bands having a frequency content between 2.3 GHz and 3 GHz, also referred to herein as HB), and/or various 5G frequency bands such as n41, n77 or n79. MHB frequency content refers to frequency content covering at least a portion of MB and at least a portion of HB, for instance, a frequency content between 1 GHz and 3 GHz.

Conventional RF front-end systems for TDD bands are typically limited by the antenna count. This is most notable in the 4 HB (2300 to 2690 MHz) or UHB (3300 to 5000 MHz) antennas in modern wireless communications devices. Use of SRS-AS requires that the uplink side of the wireless communications device is able to transmit known calibration reference signals/SRS symbols on each of the intended downlink Rx antennas using beamforming in order to establish good RF channel and environmental models for the reciprocal signal in TDD such that the base station (gNodeB) can optimize the signal-to-noise ratio (SNR) for the downlink, beamform adequately, and manage UE coexistence issues in a cell supporting directional multi-antenna operation at the gNodeB.

The use of SRS-AS enables downlink propagation channel estimation in a TDD system, which is particularly important for channels with a large dimensionality, such as in massive MIMO systems. For SRS-AS, the UE uses Rx paths to transmit the SRS signals if the number of Tx paths is less than the number of Rx paths within the UE. For example, for a system having one transmit path and two receive paths, two SRS sets will be transmitted by using one Tx to switch the signal and send it twice through the two UE Rx paths.

Although SRS provides a number of benefits, such as those outlined above, SRS-AS typically requires additional uplink connectivity to connect the Tx paths to all of the Rx-supporting antennas. This requires inline switches to handle the antenna switching and introduces additional losses in conventional RF front-end system architectures, which are undesirable.

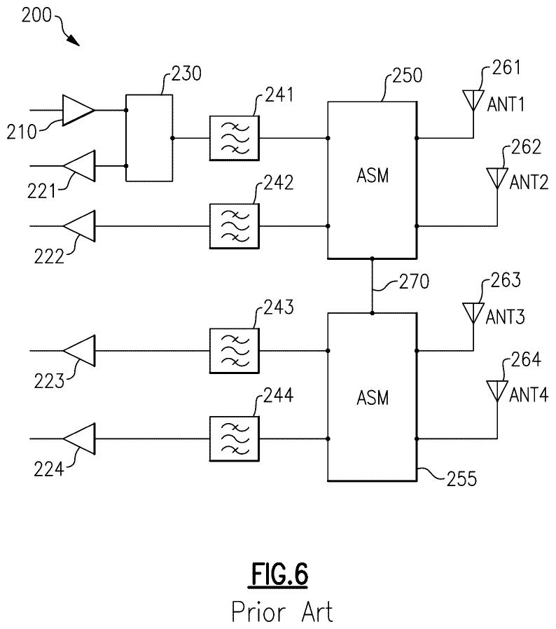

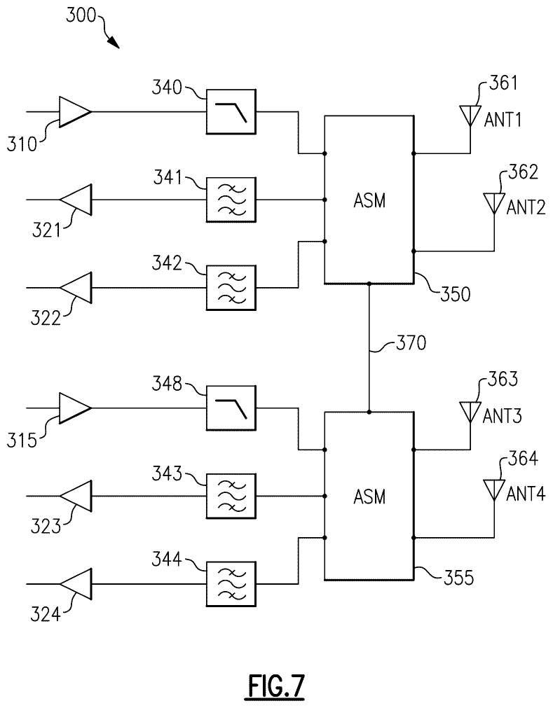

An example front-end system 200 for a radio frequency communications device for use with SRS-AS is illustrated in FIG. 6. The example front-end system 200 comprises a power amplifier (PA) 210; four low noise amplifiers (LNAs) 221, 222, 223, and 224; a Tx/Rx switch 230; four band pass filters 241, 242, 243, and 244; two antenna switch modules (ASMs) 250, and 255; four antennas ANT1 261, ANT2 262, ANT3 263, and ANT4 264; and a link trace 270.

The PA 210 may be configured to receive a radio frequency (RF) signal to be amplified, which is then amplified and passed to the band pass filter 241 for filtering via the Tx/Rx switch 230. During a transmit period, the Tx/Rx switch 230 will couple the PA 210 to the band pass filter 241 for filtering the amplified RF signal. The filtered RF signal is then passed to an antenna for transmission, for example the transmit enabled ANT1 261, via the ASM 250. ANT1 261 may also be receive enabled and configured to receive an RF signal. The received RF signal is then passed to the band pass filter 241 for filtering via the ASM 250. The filtered RF signal can then be passed to the LNA 221 via the Tx/Rx switch 230 (during a receive period, the Tx/Rx switch 230 will couple the band pass filter 241 to the LNA 221 for amplifying the filtered receive RF signal).

ANT2 262 is receive enabled and configured to receive an RF signal. The received RF signal is then passed to the band pass filter 242 for filtering via the ASM 250. The filtered RF signal can then be passed to the LNA 222 for amplifying the filtered receive RF signal. ANT3 263 is receive enabled and configured to receive an RF signal. The received RF signal is then passed to the band pass filter 243 for filtering via the ASM 255. The filtered RF signal can then be passed to the LNA 223 for amplifying the filtered receive RF signal. ANT2 264 is receive enabled and configured to receive an RF signal. The received RF signal is then passed to the band pass filter 244 for filtering via the ASM 255. The filtered RF signal can then be passed to the LNA 224 for amplifying the filtered receive RF signal.

To provide SRS-AS support, the ASM 250 is coupled to the ASM 255 by the link trace 270, which enables the PA 210 to transmit the SRS signal from each of the four antennas ANT1 261, ANT2 262, ANT3 263, and ANT4 264. However, this configuration requires many switch modules, each with many throws per switch. This switching burden introduces additional losses for the various RF paths. Typical implementations are configured to balance all of the paths such that the level of insertion loss is roughly equal between the different paths.

However, the present inventor has appreciated that at higher RF frequency ranges the trace losses and insertion losses (e.g., switch losses) start to become large and difficult to manage, which can be challenging for the link budget of the UE front-end system. When considering frequencies in the FR3 range (7 to 24 GHz) it is noted that these RF signals are already impacted by increased levels of RF environment path loss and building penetration losses, and accordingly the trace losses and insertion losses exacerbate this issue. For the transmit chain, these losses result in lower transmission power, which may need to be counteracted by increasing the power rating of the PA, which in turn will increase the size, cost, and complexity of the front-end system.

An example front-end system 300 for a radio frequency communications device according to a first embodiment of the present disclosure is illustrated in FIG. 7. The front-end system 300 comprises two PAs 310 and 315; four LNAs 321, 322, 323, and 324; two low pass filters 340 and 348; four band pass filters 341, 342, 343, and 344; two ASMs 350, and 355; four antennas ANT1 361, ANT2 362, ANT3 363, and ANT4 364; and a link trace 370.

The PA 310 may be configured to receive a radio frequency (RF) signal to be amplified, which is then amplified and passed to the low pass filter 341 for filtering the amplified RF signal. During a transmit period, the ASM 350 will couple the low pass filer 340 to an antenna for transmission, for example the transmit enabled ANT1 361.

ANT1 361 may also be receive enabled and configured to receive an RF signal. During a receive period, the ASM 350 will couple the antenna ANT1 361 to the band pass filter 341; accordingly, the received RF signal is then passed to the band pass filter 341 for filtering. The filtered RF signal can then be passed to the LNA 321. ANT2 362 is receive enabled and also configured to receive an RF signal. The received RF signal is then passed to the band pass filter 342 for filtering via the ASM 350. The filtered RF signal can then be passed to the LNA 322 for amplifying the filtered receive RF signal. In this manner, each Rx path/LNA 321, 322 is connectable to a respective antenna 361, 362, while the Tx path/PA 310 is connectable to each of these antennas 361, 362.

The PA 315 may also be configured to receive another radio frequency (RF) signal to be amplified, which is then amplified and passed to the low pass filter 348 for filtering the amplified RF signal. During a transmit period, the ASM 355 may couple the low pass filer 348 to an antenna for transmission, for example the transmit enabled ANT3 363.

ANT3 363 may also be receive enabled and configured to receive an RF signal. During a receive period, the ASM 355 will couple the antenna ANT3 363 to the band pass filter 343; accordingly, the received RF signal is then passed to the band pass filter 343 for filtering. The filtered RF signal can then be passed to the LNA 323. ANT4 364 is receive enabled and also configured to receive an RF signal. The received RF signal is then passed to the band pass filter 344 for filtering via the ASM 355. The filtered RF signal can then be passed to the LNA 324 for amplifying the filtered receive RF signal. In this manner, each Rx path/LNA 323, 324 is connectable to a respective antenna 363, 364, while the Tx path/PA 315 is connectable to each of these antennas 363, 364.

In comparison to the front-end system 200, the front-end system 300 replaces the Tx/Rx switch 230 and the band pass filter 241 with a pair of filters 340, 341 that may be optimized for the relevant transmit/receive (Tx/Rx) frequency bands of PA 310 and LNA 321. By providing separate filters 340, 341 that are each dedicated for Tx and Rx signals respectively, they can both be tuned for lower loss and the omission of the Tx/Rx switch 230 also reduces the insertion losses of the front-end system 300. The use of a separate Tx filter 340 may also be less restrictive for out-of-band (OOB) attenuation and offer less loss in-band for lower a DC current, which in turn provides a higher gain/output power capability.

The ASMs 350 and 355 of FIG. 7 are also illustrated as being coupled by a link trace 370. This enables the PA 310 to also connect to the paths coupling with the antennas ANT3 363 and ANT4 364 of the second ASM 355 for SRS-AS transmissions.

Another difference between FIG. 7 and FIG. 6 is the inclusion of the second PA 315. Placing this PA 315 in association with the second ASM 355 enables SRS-AS signals for the antennas associated with the second ASM 355 (ANT3 363 and ANT4 364) to be driven with shorter signal paths, and therefore lower path losses, than would be achievable by driving these antennas from the PA 310. In this configuration, SRS-AS signals can be sent from all of the antennas by providing the same signal to both the PA 310 and the PA 315, and then driving ANT1 361 and ANT2 362 with the PA 310, and driving ANT3 363 and ANT4 364 with the PA 315. In such a configuration, the link trace 370 may be omitted. Accordingly, it will be appreciated that the illustrated link trace 370 of FIG. 7 is optional. This configuration with multiple PAs and Tx paths may also enable Tx diversity transmissions and uplink MIMO (UL-MIMO) communications.

In configurations including a link trace 370, this may be implemented as a single trace that provides bi-directional coupling between the relevant paths of the respective ASMs 350 and 355. Alternatively, multiple unidirectional paths may be used in some configurations.

While the filters 340 and 348 for the respective PAs 310 and 315 are illustrated and described above as being low pass filters, it will be appreciated that these could be replaced with suitably configured band pass filters in some configurations.

The four antennas may be omitted from the front-end system 300 and replaced with respective antenna contacts to form a front-end module configuration that is suitable for connecting to suitable antennas. Similarly, a corresponding radio frequency circuit assembly may be provided that provides transmit signal contacts to replace the PAs and receive signal contacts to replace the LNAs. In this manner, the radio frequency circuit assembly may provide the required filter and switching path described above while providing contacts that may be connected to suitable PAs, LNAs, and antennas.

The example configuration of a radio frequency circuit assembly, front-end module, and front-end system described above includes two PAs, four LNAs, and four antennas (or contacts for connection thereto). It will be appreciated that the number of antennas and respective LNAs may be increased in further examples. These additional antennas and LNAs (or corresponding contacts) may be provided at the ASM 350, or at the ASM 355, or at both ASMs. Furthermore, one or more additional ASMs may be provided to couple further antennas and LNAs. Optionally, these additional ASMs may also include corresponding additional PAs.

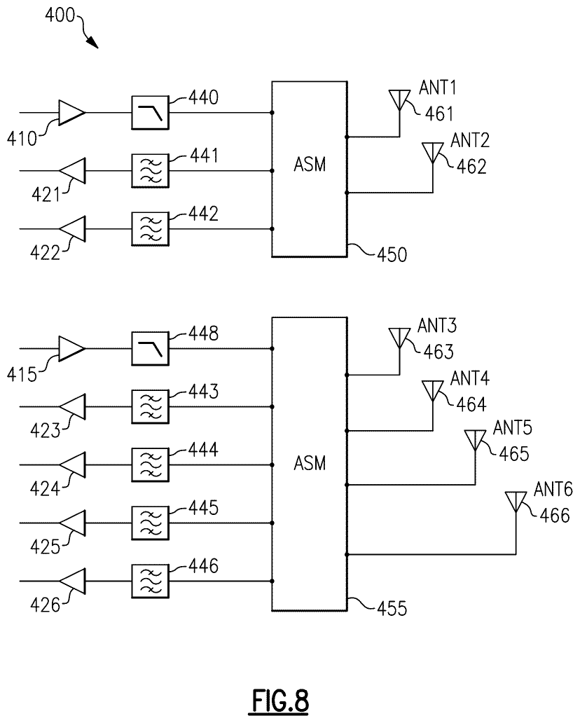

An example of a front-end system 400 for a radio frequency communications device according to a second embodiment of the present disclosure is illustrated in FIG. 8. The front-end system 400 comprises two PAs 410 and 415; six LNAs 421, 422, 423, 424, 425, and 426; two low pass filters 440 and 448; six band pass filters 441, 442, 443, 444, 445, and 446; two ASMs 450, and 455; and six antennas ANT1 461, ANT2 462, ANT3 463, ANT4 464, ANT5 465, and ANT6 466.

The PA 410 may be configured to receive a radio frequency (RF) signal to be amplified, which is then amplified and passed to the low pass filter 441 for filtering the amplified RF signal. During a transmit period, the ASM 450 will couple the low pass filer 440 to an antenna for transmission, for example the transmit enabled ANT1 461.

ANT1 461 may also be receive enabled and configured to receive an RF signal. During a receive period, the ASM 450 will couple the antenna ANT1 461 to the band pass filter 441; accordingly, the received RF signal is then passed to the band pass filter 441 for filtering. The filtered RF signal can then be passed to the LNA 421. ANT2 462 is receive enabled and also configured to receive an RF signal. The received RF signal is then passed to the band pass filter 442 for filtering via the ASM 450. The filtered RF signal can then be passed to the LNA 422 for amplifying the filtered receive RF signal. In this manner, each Rx path/LNA 421, 422 is connectable to a respective antenna 461, 462, while the Tx path/PA 410 is connectable to each of these antennas 461, 462.

The PA 415 may also be configured to receive another radio frequency (RF) signal to be amplified, which is then amplified and passed to the low pass filter 448 for filtering the amplified RF signal. During a transmit period, the ASM 455 may couple the low pass filer 448 to an antenna for transmission, for example the transmit enabled ANT3 463.

ANT3 463 may also be receive enabled and configured to receive an RF signal. During a receive period, the ASM 455 will couple the antenna ANT3 463 to the band pass filter 443; accordingly, the received RF signal is then passed to the band pass filter 443 for filtering. The filtered RF signal can then be passed to the LNA 423. ANT4 464 is receive enabled and also configured to receive an RF signal. The received RF signal is then passed to the band pass filter 444 for filtering via the ASM 455. The filtered RF signal can then be passed to the LNA 424 for amplifying the filtered receive RF signal. ANT5 465 is receive enabled and also configured to receive an RF signal. The received RF signal is then passed to the band pass filter 445 for filtering via the ASM 455. The filtered RF signal can then be passed to the LNA 425 for amplifying the filtered receive RF signal. ANT6 466 is receive enabled and also configured to receive an RF signal. The received RF signal is then passed to the band pass filter 446 for filtering via the ASM 455. The filtered RF signal can then be passed to the LNA 426 for amplifying the filtered receive RF signal. In this manner, each Rx path/LNA 423, 424, 425, 426 is connectable to a respective antenna 463, 464, 465, 466, while the Tx path/PA 415 is connectable to each of these antennas 463, 464, 465, 466.

In comparison to the front-end system 300, the front-end system 400 provides an ASM 455 having two additional sets of antennas, filters, and LNAs. It will be appreciated that this could be expanded to an arbitrary number of antenna, filter, and LNA sets. The link trace has also been omitted from this example; however, it will be appreciated that this could be included in some configurations as discussed above in respect of the front-end system 300.

The increased antenna count at the second ASM 455 places a higher switching burden (for example during SRS-AS activity) on the ASM 455 in comparison to the ASM 450; however this also enables a reduced signal to noise ratio for the signal processing. The use of a PA that is also coupled to the same ASM also helps to maintain low insertion loss levels.

This configuration is particularly suitable for the higher frequency FR3 range, since the resonant dimensioning of antennas is proportional to wavelength, which decreases for these higher frequency ranges. Therefore the physical size of antennas configured for these higher frequency ranges can be smaller and thus a higher antenna count can be provided in the same physical area of a device. In some examples, these antenna may be dedicated to transmission and reception of FR3 band RF signals.

It should be appreciated that the six antennas may be omitted from the front-end system 400 and replaced with respective antenna contacts to form a front-end module configuration that is suitable for connecting to suitable antennas. Similarly, a corresponding radio frequency circuit assembly may be provided that provides transmit signal contacts to replace the PAs and receive signal contacts to replace the LNAs. In this manner, the radio frequency circuit assembly may provide the required filter and switching path described above while providing contacts that may be connected to suitable PAs, LNAs, and antennas.

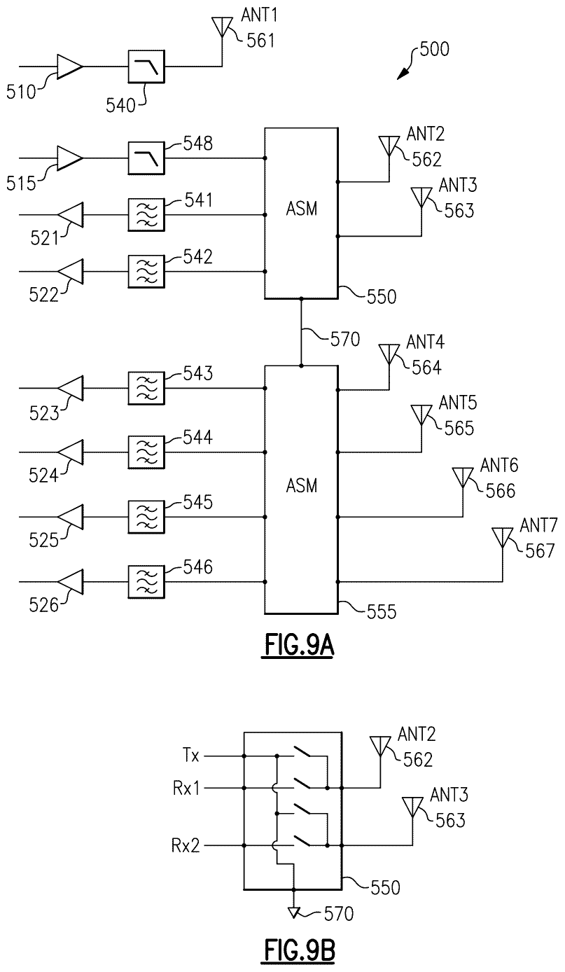

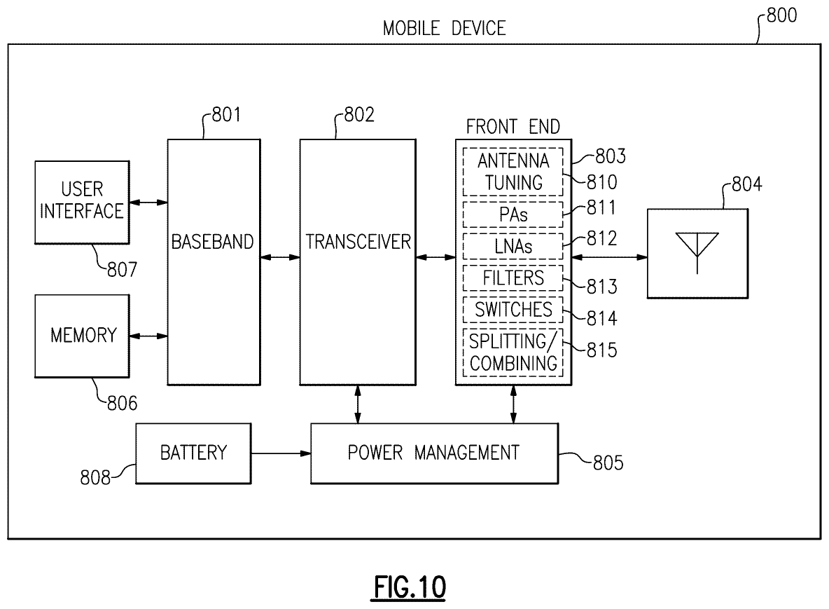

An example of a front-end system 500 for a radio frequency communications device according to a third embodiment of the present disclosure is illustrated in FIG. 9A. The front-end system 500 comprises two PAs 510 and 515; six LNAs 521, 522, 523, 524, 525, and 526; two low pass filters 540 and 548; six band pass filters 541, 542, 543, 544, 545, and 546; two ASMs 550, and 555; six antennas ANT1 561, ANT2 562, ANT3 563, ANT4 564, ANT5 565, and ANT6 566; and a link trace 570.

The PA 510 may be configured to receive a radio frequency (RF) signal to be amplified, which is then amplified and passed to the low pass filter 540 for filtering the amplified RF signal. The filtered RF signal may then be passed to a dedicated transmit antenna ANT1 561. Accordingly, this RF path can be considered to be a simplex configuration that is dedicated to RF transmission with no receive support. This means that no switching is required on this path and the insertion losses can be minimized accordingly.

The PA 515 may also be configured to receive a radio frequency (RF) signal to be amplified, which is then amplified and passed to the low pass filter 548 for filtering the amplified RF signal. During a transmit period, the ASM 550 will couple the low pass filer 548 to an antenna for transmission, for example the transmit enabled ANT2 562.

ANT2 562 may also be receive enabled and configured to receive an RF signal. During a receive period, the ASM 550 will couple the antenna ANT2 562 to the band pass filter 541; accordingly, the received RF signal is then passed to the band pass filter 541 for filtering. The filtered RF signal can then be passed to the LNA 521. ANT3 563 is receive enabled and also configured to receive an RF signal. The received RF signal is then passed to the band pass filter 542 for filtering via the ASM 550. The filtered RF signal can then be passed to the LNA 522 for amplifying the filtered receive RF signal. In this manner, each Rx path/LNA 521, 522 is connectable to a respective antenna 562, 563, while the Tx path/PA 515 is connectable to each of these antennas 562, 563.

ANT4 564 may also be receive enabled and configured to receive an RF signal. During a receive period, the ASM 555 will couple the antenna ANT4 564 to the band pass filter 543; accordingly, the received RF signal is then passed to the band pass filter 543 for filtering. The filtered RF signal can then be passed to the LNA 523. ANT5 565 is receive enabled and also configured to receive an RF signal. The received RF signal is then passed to the band pass filter 544 for filtering via the ASM 555. The filtered RF signal can then be passed to the LNA 524 for amplifying the filtered receive RF signal. ANT6 566 is receive enabled and also configured to receive an RF signal. The received RF signal is then passed to the band pass filter 545 for filtering via the ASM 555. The filtered RF signal can then be passed to the LNA 525 for amplifying the filtered receive RF signal. ANT7 567 is receive enabled and also configured to receive an RF signal. The received RF signal is then passed to the band pass filter 546 for filtering via the ASM 555. The filtered RF signal can then be passed to the LNA 526 for amplifying the filtered receive RF signal.

The ASMs 550 and 555 of FIG. 9A are also illustrated as being coupled by a link trace 570. This link enables the PA 515 to also be connectable to the paths coupling with the antennas ANT4 564, ANT5 565, ANT6 566, and ANT7 567 of the second ASM 555 for SRS-AS transmissions. In this manner, each Rx path/LNA 523, 524, 525, 526 is connectable to a respective antenna 564, 565, 566, 567 via the ASM 555, while the Tx path/PA 515 is connectable to each of these antennas 564, 565, 566, 567 as well as the antennas 562, 563 that are local to the same ASM 550 as the PA 515.

An example of an internal circuit for an ASM 550 is illustrated in FIG. 9B. As can be seen from this figure, the Rx1 path (which may be coupled to LNA 521 via the band pass filter 541) is switchably/selectively connected to antenna ANT2 562, and the Rx2 path (which may be coupled to LNA 522 via the band pass filter 542) is switchably/selectively connected to antenna ANT3 563. The Tx path (which may be coupled to PA 515 via the low pass filter 548) is switchably/selectively connected to both antennas ANT2 562, and ANT3 563, as well as the link trace 570 for coupling to the ASM 555.

Such a configuration enables the PA 515 to power SRS-AS transmissions from all of the receive enabled antennas 562, 563, 564, 565, 566, 567, and this can be adapted to support any arbitrary number of LNA, filter, and antenna sets as described above with respect to the first and second embodiments of the present disclosure. The provision of both PA 515 and PA 510 further enables the front-end system 500 to support UL-MIMO and transmissions utilizing transmit diversity. However, the provision of a dedicated simplex transmit path from PA 510 enables a low loss transmit path to feed the transmit antenna ANT1 561 with no switching required and a comparatively short trace path from the PA to the antenna ANT1 561. In this manner, the dedicated transmit path can be optimized for low loss RF transmission, thus improving the output power capability of the PA 510.

For transmissions that do not require UL-MIMO or transmit diversity, the PAs 510 and 515 may be configured to receive the same RF signal for amplification and to operate concurrently such that the total transmission output power for the amplified (and filtered) RF signal is a combination of that from the PA 510 and the PA 515. In another example, the PA 510 may be configured to have a higher output power capability than the PA 515 for an improved transmission signal to noise ratio.

It should be appreciated that the six antennas may be omitted from the front-end system 500 and replaced with respective antenna contacts to form a front-end module configuration that is suitable for connecting to suitable antennas. Similarly, a corresponding radio frequency circuit assembly may be provided that provides transmit signal contacts to replace the PAs and receive signal contacts to replace the LNAs. In this manner, the radio frequency circuit assembly may provide the required filter and switching path described above while providing contacts that may be connected to suitable PAs, LNAs, and antennas. Prior known configurations are typically arranged to balance all of the RF paths such that the level of insertion loss is roughly equal between the different paths. Accordingly, these known configurations have not been able to provide a lower loss transmit path as set out above in the third embodiment of the present disclosure. The reduction of insertion losses by removing all switching from the dedicated transmit path enables lower losses and a lower DC current consumption for that transmit path. This also enables the connectivity and switch throw design of ASMs to be optimized for improved receive performance.

It should be appreciated that some examples may combine various aspects of FIGS. 7, 8, 9A and 9B to include multiple ASMs featuring receive only capability as depicted in FIG. 9A by ASM 555, as well as ASMs with transmit and receive capability as depicted in FIG. 8 by ASM 455, with or without a simplex transmit configuration as depicted in FIG. 9A.

The front-end systems, front-end modules, and radio frequency circuit assemblies described above may be configured for use in a wireless communication device. Such wireless communication devices may be one of a mobile device, an automotive electronics device, a base station, a network access points, or other customer-premises equipment. Customer-premises equipment and automotive electronics devices may not have the same space restrictions as typical mobile devices, and accordingly there may be additional space for an even higher antenna count than these typical mobile device configurations. Accordingly, the principles of the present disclosure may be particularly applicable to such customer-premises equipment and automotive electronics devices use cases.

While the ASM 555 of FIG. 9A is illustrated as being locally coupled to only receive paths with LNAs, it will be appreciated that the ASM 555 could also be coupled to a further PA and corresponding low pass filter that are local to the ASM 555. As discussed above in relation to FIG. 7, the link trace 570 may be optional in such a configuration as the further local PA could be configured to receive the same RF signals for SRS-AS transmission such that ANT2 562 and ANT3 563 are driven by the PA 515, and ANT4 564, ANT5 565, ANT6 566, and ANT7 567 are driven by the further local PA.

Radio frequency circuit assemblies disclosed herein can be implemented in the front-end modules of wireless communication devices. The radio frequency circuit assemblies may be implemented in a discrete form with constituent discrete components (e.g., the power amplifier components, the acoustic filter components, the ASM, the LNA, switches, and/or the baluns) formed directly on the printed circuit board (PCB) of the wireless communication device. Alternatively, an integrated module, such as a multi-chip module (MCM), may include each of these components, with the components either being patterned directly into the MCM PCB, or attached via dies. The finished module may then be over molded for protection and packaging.

FIG. 10 is a schematic block diagram of a wireless communication device 800 that includes a radio frequency circuit assembly according to an embodiment. The wireless communication device 800 can be a mobile device. The wireless communication device 800 can be any suitable wireless communication device. For instance, a wireless communication device 800 can be a mobile phone, such as a smart phone, or an item of Customer Premises Equipment (CPE). As illustrated, the wireless communication device 800 includes a baseband system 801, a transceiver 802, a front end system 803, one or more antennas 804, a power management system 805, a memory 806, a user interface 807, and a battery 808.

The wireless communication device 800 can communicate using a wide variety of communications technologies, including, but not limited to, 2G, 3G, 4G (including LTE, LTE-Advanced, and/or LTE-Advanced Pro), 5G NR, WLAN (for instance, Wi-Fi), WPAN (for instance, Bluetooth and/or ZigBee), WMAN (for instance, WiMax), and/or GPS technologies.

The transceiver 802 generates RF signals for transmission and processes incoming RF signals received from the antennas 804. Various functionalities associated with the transmission and receiving of RF signals can be achieved by one or more components that are collectively represented in FIG. 10 as the transceiver 802. In one example, separate components (for instance, separate circuits or dies) can be provided for handling certain types of RF signals.

The front end system 803 aids in conditioning signals provided to and/or received from the antennas 804. In the illustrated embodiment, the front end system 803 includes antenna tuning circuitry 810, power amplifiers (PAs) 811, low noise amplifiers (LNAs) 812, filters 813, switches 814, and signal splitting/combining circuitry 815. However, other implementations are possible. The front end system 803 can include one or more radio frequency circuit assemblies in accordance with any suitable principles and advantages disclosed herein. For example, the filters 813 may comprise differentially arranged band pass filters arranged within a radio frequency circuit assembly in accordance with any suitable principles and advantages disclosed herein.

The front end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals, or any suitable combination thereof.

In certain implementations, the wireless communication device 800 supports carrier aggregation, thereby providing flexibility to increase peak data rates. Carrier aggregation can be used for Frequency Division Duplexing (FDD) and/or Time Division Duplexing (TDD), and may be used to aggregate a plurality of carriers and/or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The wireless communication device 800 can operate with beamforming in certain implementations. For example, the front end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 10, the baseband system 801 is coupled to the memory 806 of facilitate operation of the wireless communication device 800.

The memory 806 can be used for a wide variety of purposes, such as storing data and/or instructions to facilitate the operation of the wireless communication device 800 and/or to provide storage of user information.

The power management system 805 provides a number of power management functions of the wireless communication device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 10, the power management system 805 receives a battery voltage from the battery 808. The battery 808 can be any suitable battery for use in the wireless communication device 800, including, for example, a lithium-ion battery.

Any of the embodiments described above can be implemented in association with mobile devices such as cellular handsets. The principles and advantages of the embodiments can be used for any systems or apparatus, such as any uplink wireless communication device, that could benefit from any of the embodiments described herein. The teachings herein are applicable to a variety of systems. Although this disclosure includes example embodiments, the teachings described herein can be applied to a variety of structures. Any of the principles and advantages discussed herein can be implemented in association with RF circuits configured to process signals having a frequency in a range from about 30 kHz to 350 GHz, such as in a frequency range from about 400 MHz to 25 GHz or in a frequency range from about 7.125 GHz to about 24.250.

Aspects of this disclosure can be implemented in various electronic devices. Examples of the electronic devices can include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, a camera such as a digital camera, a portable memory chip, a home appliance such as a washer or a dryer, a peripheral device, a wrist watch, a clock, etc. Further, the electronic devices can include unfinished products.

Conditional language used herein, such as, among others, “can,” “could,” “might,” “may,” “e.g.,” “for example”, “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

The examples shown in the figures illustrate the filter components or filtering stages as discrete “blocks”. Those skilled in the art will appreciate, given the benefit of this disclosure, that any or all of the filters shown in the various examples may be made up of many stages and/or combined or share components in different physical implementations. Accordingly, the examples shown in FIGS. 7 to 9 are intended to be functional illustrations and not limiting in any aspect with respect to actual implementations of the radio frequency circuit assembly or front-end module. Aspects and embodiments provide a noise cancellation approach that can be designed into the overall front-end module configuration such that the overall filter out-of-band attenuations required can be relaxed, requirements on some or all the filter sections may be relaxed to provide more optimal and lower insertion losses, and the net insertion loss and out-of-band attenuation / isolation properties of the entire front-end module may exhibit less loss, more isolation, and more out-of-band attenuation where desired.

While certain embodiments have been described, these embodiments have been presented by way of example only, and are not intended to limit the scope of the disclosure. Indeed, the novel resonators, filters, modules, devices, wireless communication devices, apparatus, and systems described herein may be embodied in a variety of other forms. Furthermore, various omissions, substitutions and changes in the form of the resonators, filters, modules, devices, wireless communication devices, apparatus, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. Accordingly, the foregoing description and drawings are by way of example only, and the scope of the invention should be determined from proper construction of the appended claims, and their equivalents.

What is claimed is:

1. A radio frequency circuit assembly, comprising:
a first transmit signal contact and a second transmit signal contact, each transmit signal contact being configured to receive a respective amplified radio frequency transmit signal;
a first plurality of receive signal contacts and a second plurality of receive signal contacts, each receive signal contact being couplable to a respective low noise amplifier;
a first plurality of antenna contacts and a second plurality of antenna contacts, each antenna contact being couplable to a respective antenna;
a first antenna switching module that is coupled to the first transmit signal contact via a first transmit band filter, the first antenna switching module being coupled to the first plurality of receive signal contacts via a respective first plurality of receive band filters, and the first antenna switching module being coupled to the first plurality of antenna contacts such that each of the first plurality of antenna contacts are selectively coupled to the first transmit signal contact; and
a second antenna switching module that is coupled to the second transmit signal contact via a second transmit band filter, the second antenna switching module being coupled to the second plurality of receive signal contacts via a respective second plurality of receive band filters, and the second antenna switching module being coupled to the second plurality of antenna contacts such that each of the second plurality of antenna contacts are selectively coupled to the second transmit signal contact.

2. The radio frequency circuit assembly of claim 1 wherein the first antenna switching module is coupled to the second antenna switching module by a trace such that each of the second plurality of antenna contacts are selectively coupled to the first transmit signal contact.

3. The radio frequency circuit assembly of claim 1 wherein the first transmit band filter and the second transmit band filter are low pass filters, and the first plurality of receive band filters and the second plurality of receive band filters are band pass filters.

4. The radio frequency circuit assembly of claim 1 wherein the respective radio frequency transmit signals have a frequency in a range of 7 gigahertz to 24 gigahertz.

5. The radio frequency circuit assembly of claim 1 wherein the radio frequency circuit assembly is configured to provide sounding reference signaling by transmitting the radio frequency transmit signal using the first and second plurality of antenna contacts.

6. The radio frequency circuit assembly of claim 1 wherein the first plurality of receive signal contacts are respectively selectively coupled to the first plurality of antenna contacts, and the second plurality of receive signal contacts are respectively selectively coupled to the second plurality of antenna contacts.

7. A front-end module, comprising:
a first power amplifier and a second power amplifier, each power amplifier being configured to receive a respective radio frequency transmit signal for amplification;
a first plurality of low noise amplifiers and a second plurality of low noise amplifiers;
a first plurality of antenna contacts and a second plurality of antenna contacts, each antenna contact being couplable to a respective antenna;
a first antenna switching module that is coupled to the first power amplifier via a first transmit band filter, the first antenna switching module being coupled to the first plurality of low noise amplifiers via a respective first plurality of receive band filters, and the first antenna switching module being coupled to the first plurality of antenna contacts such that each of the first plurality of antenna contacts are selectively coupled to the first power amplifier; and
a second antenna switching module that is coupled to the second power amplifier via a second transmit band filter, the second antenna switching module being coupled to the second plurality of low noise amplifiers via a respective second plurality of receive band filters, and the second antenna switching module being coupled to the second plurality of antenna contacts such that each of the second plurality of antenna contacts are selectively coupled to the second power amplifier.

8. The front-end module of claim 7 wherein the first antenna switching module is coupled to the second antenna switching module by a trace such that each of the second plurality of antenna contacts are selectively coupled to the first power amplifier.

9. The front-end module of claim 7 wherein the first transmit band filter and the second transmit band filter are low pass filters, and the first plurality of receive band filters and the second plurality of receive band filters are band pass filters.

10. The front-end module of claim 7 wherein the first power amplifier and the second power amplifier are configured for concurrent transmission of amplified radio frequency transmit signals.

11. The front-end module of claim 7 wherein the respective radio frequency transmit signals have a frequency in a range of 7 gigahertz to 24 gigahertz.

12. The front-end module of claim 7 wherein the radio frequency circuit assembly is configured to provide sounding reference signaling by transmitting the radio frequency transmit signal using the first and second plurality of antenna contacts.

13. The front-end module of claim 7 wherein the first plurality of low noise amplifiers are respectively selectively coupled to the first plurality of antenna contacts, and the second plurality of low noise amplifiers are respectively selectively coupled to the second plurality of antenna contacts.

14. A radio frequency circuit assembly, comprising:
a first transmit signal contact and a second transmit signal contact, each transmit signal contact being configured to receive a respective amplified radio frequency transmit signal;
a plurality of receive signal contacts, each receive signal contact being couplable to a respective low noise amplifier;
a first antenna contact and a plurality of second antenna contacts, each antenna contact being couplable to a respective antenna;
a first transmit band filter connected to the first transmit signal contact and the first antenna contact; and
an antenna switching module that is coupled to the second transmit signal contact via a second transmit band filter, the antenna switching module being coupled to the plurality of receive signal contacts via a respective plurality of receive band filters, and the antenna switching module being coupled to the plurality of second antenna contacts such that each of the plurality of second antenna contacts are selectively coupled to the second transmit signal contact.

15. The radio frequency circuit assembly of claim 14 wherein the first antenna contact is only connected to the transmit path from the first transmit signal contact and the first transmit band filter.

16. The radio frequency circuit assembly of claim 14 wherein the first antenna contact is not connected to a switch.

17. The radio frequency circuit assembly of claim 14 wherein the plurality of receive signal contacts are respectively selectively coupled to the plurality of second antenna contacts.

18. The radio frequency circuit assembly of claim 14 further comprising a second antenna switching module that is coupled to a second plurality of receive signal contacts via a respective second plurality of receive band filters, the second antenna switching module being coupled to a plurality of third antenna contacts such that each of the plurality of third antenna contacts are respectively selectively coupled to the second plurality of receive signal contacts.

19. The radio frequency circuit assembly of claim 18 wherein the antenna switching module is coupled to the second antenna switching module by a trace such that each of the plurality of third antenna contacts are selectively coupled to the second transmit signal contact.

20. The radio frequency circuit assembly of claim 18 further comprising a third transmit signal contact, the second antenna switching module being coupled to the third transmit signal contact via a third transmit band filter, and each of the plurality of third antenna contacts being selectively coupled to the third transmit signal contact.
